(19) United States
(12) Patent Application Publication
(10) Pub. No.: US 2008/0315557 A1
(43) Pub. Date: Dec. 25, 2008

(54) Apparatus and methods for remotely controlling fifth wheel hitch assembly

(76) Inventors: Eric Stanifer, Mishawaka, IN (US); James M. Karasch, Elkhart, IN (US); Richard W. McCoy, Granger, IN (US); Thomas Benson, Northville, MI (US)

Correspondence Address: MCDONALD HOPKINS LLC, 600 Superior Avenue, East, Suite 2100, CLEVELAND, OH, 44114-2653, US

(21) Appl. No.: 11/985,109

(22) Filed: Nov. 14, 2007

Related U.S. Application Data
(60) Provisional application No. 60/858,864, filed on Nov. 14, 2006.

(51) Int. Cl. B62D 53/12

(52) U.S. Cl. 280/434

(57) ABSTRACT

Apparatus, methods, and other embodiments for fifth wheel hitch assemblies are described herein. In one embodiment, a remotely controlled fifth wheel hitch assembly comprises a mounting rail, a head assembly, a locking arm, an actuation mechanism, and a remote control device. The mounting rail is coupled to a towing vehicle and the head assembly is slidably coupled to the mounting rail. The head assembly is capable of securing a trailer to the towing vehicle. The locking arm includes a locked position and an unlocked position. In the locked position, the head assembly is statically secured to the mounting rail. The actuation mechanism is coupled to the locking arm to move the locking arm between the locked and unlocked positions. The remote control device is coupled to the actuation mechanism such that the remote control initiates the actuation mechanism to move the locking arm between the locked and unlocked positions.

### CROSS-REFERENCE TO RELATED APPLICATION

The application claims priority from U.S. Provisional Patent Application No. 60/858,864, entitled “APPARATUS AND METHODS FOR REMOTELY CONTROLLING FIFTH WHEEL HITCH ASSEMBLIES,” filed on Nov. 14, 2006, which is hereby incorporated by reference in its entirety.

### FIELD OF INVENTION

The present invention relates generally to apparatus and methods for remotely controlling fifth wheel hitch assemblies, more specifically, the present invention relates to novel and improved apparatus and methods for remotely locking and unlocking fifth wheel hitch assemblies.

### BACKGROUND

Many towing vehicles are designed to tow, haul, or otherwise transport freight, goods, merchandise, personal property, and other such cargo. Often, a trailer arranged to carry such cargo is attached or coupled to a towing vehicle so that the towing vehicle may effectively tow the cargo. One type of trailer that may be attached to towing vehicles is a fifth wheel trailer. A towing vehicle hauling a fifth wheel trailer commonly utilizes a fifth wheel hitch assembly to attach the trailer to the towing vehicle. Fifth wheel hitch assemblies are typically secured to a flat bed of the towing vehicle. Vehicles such as pick-up trucks or flatbed trucks include flat beds and may be arranged to accommodate a fifth wheel hitch assembly, thus accommodating a fifth wheel trailer.

Fifth wheel trailers may be arranged with a king pin to secure the trailer to the hitch assembly. The king pin may be placed into a securing mechanism, such as a jaw, arranged on the hitch assembly. Once positioned in the jaw, the king pin may be secured in the jaw, which secures the king pin to the hitch assembly and, thus secures the trailer to the towing vehicle.

It is desirable to develop novel apparatus, systems, arrangements, and methods for incorporating fifth wheel hitch assemblies into towing vehicles and securing fifth wheel trailers to such fifth wheel assemblies. Novel apparatus, systems, arrangements, and methods may, for example, improve the safe operation or general usability of fifth wheel hitch assemblies and fifth wheel trailers.

### SUMMARY

Apparatus, methods, and other embodiments for fifth wheel hitch assemblies are described herein. In one embodiment, a remotely controlled fifth wheel hitch assembly comprises a mounting rail, a head assembly, a locking arm, an actuation mechanism, and a remote control device. The mounting rail is coupled to a towing vehicle and the head assembly is slidably coupled to the mounting rail. The head assembly is capable of securing a trailer to the towing vehicle. The locking arm includes a locked position and an unlocked position. In the locked position, the head assembly is statically secured to the mounting rail. The actuation mechanism is coupled to the locking arm to move the locking arm between the locked and unlocked positions. The remote control device is coupled to the actuation mechanism such that the remote control initiates the actuation mechanism to move the locking arm between the locked and unlocked positions.

### BRIEF DESCRIPTION OF THE DRAWING

In the accompanying drawings, which are incorporated in and constitute a part of this specification, embodiments of the invention are illustrated that, together with a general description of the invention given above and the detailed description given below, serve to illustrate the principles of this invention. The drawings and detailed description are not intended to and do not limit the scope of the invention or the claims in any way. Instead, the drawings and detailed description only describe embodiments of the invention, and other embodiments of the invention not described are encompassed by the claims.

FIG. 1 is a schematic illustration of a fifth wheel trailer coupled to a towing vehicle;

FIG. 2 is a schematic illustration of a fifth wheel trailer positioned at a sharp angle to a towing vehicle;

FIG. 3 illustrates a perspective view of a linear slide actuator assembly for a fifth wheel hitch assembly;

FIG. 4 illustrates a perspective view of a head assembly;

FIG. 5 illustrates a perspective view of the linear slide actuator assembly of FIG. 3, with a piston in a fully retracted position;

FIG. 6 illustrates a perspective view of the linear slide actuator assembly of FIG. 3, with the piston in a partially extended position;

FIG. 7 illustrates a perspective view of the linear slide actuator assembly of FIG. 3, with the piston in a fully extended position;

FIG. 8 illustrates views of a bracket assembly of the linear slide actuator assembly of FIG. 3;

FIG. 9 illustrates views of a component of the bracket assembly of FIG. 8;

FIG. 10 illustrates views of a component of the bracket assembly of FIG. 8;

FIG. 11 illustrates views of a component of a cam arm assembly of the linear slide actuator assembly of FIG. 3;

FIG. 12 illustrates views of a component of the cam arm assembly of the linear slide actuator assembly of FIG. 3;

FIG. 13 illustrates views of a sleeve of the cam arm assembly of the linear slide actuator assembly of FIG. 3;

FIG. 14 illustrates a perspective view of a remote control device for use with fifth wheel hitch assemblies;

FIG. 15 illustrates a perspective view of a gearbox for use with fifth wheel hitch assemblies;

FIG. 16 illustrates a perspective view of the gearbox of FIG. 15;

FIG. 17 illustrates a partial cross-sectional view of the gearbox of FIG. 15; and

FIG. 18 illustrates an exploded view of the gearbox of FIG. 15.

### DETAILED DESCRIPTION OF THE INVENTION

While the present invention is described with reference to the embodiments described herein, it should be clear that the present invention should not be limited to such embodiments. Therefore, the description of the embodiments herein is illustrative of the present invention and should not limit the scope of the invention as claimed. As described herein, the present invention provides for novel apparatus and methods for remotely controlling fifth wheel hitch assemblies; however, upon understand the detailed description and accompanying figures, it will be readily understood by one of ordinary skill in the art that embodiments of the described and illustrated apparatus and methods may be incorporated with a variety of other towing vehicles, fifth wheel hitch assemblies, and fifth wheel trailers to facilitate the towing and maneuvering of trailers.

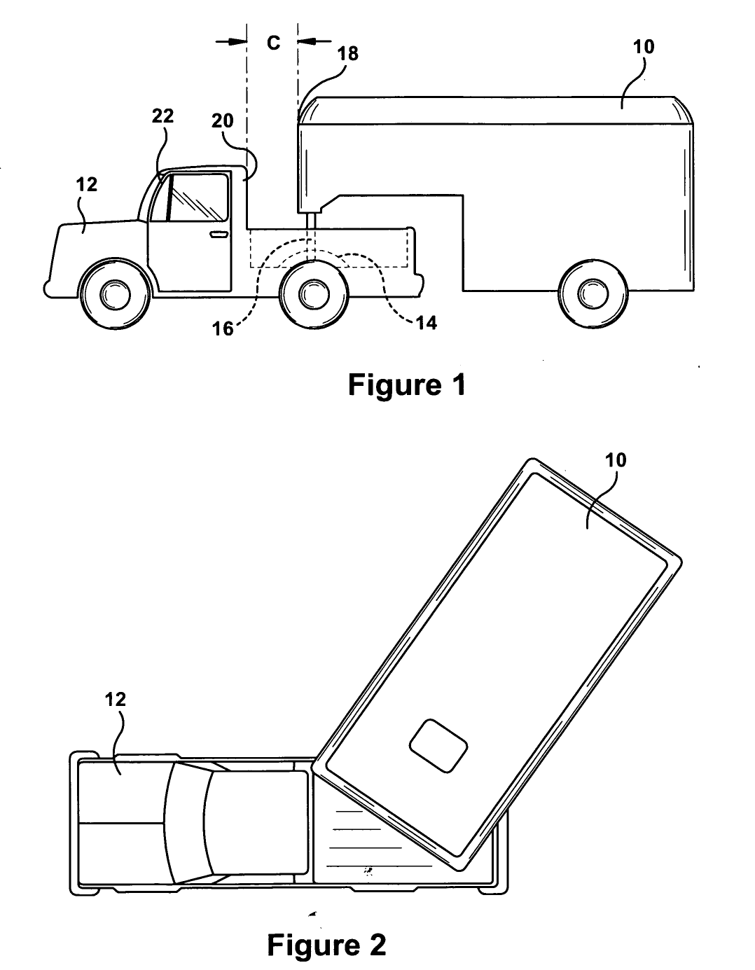

FIGS. 1 and 2 schematically illustrate exemplary embodiments of a fifth wheel trailer 10 coupled or otherwise attached to a towing vehicle 12. The towing vehicle 12 may be a pick-up truck or other such vehicle equipped with a flat bed. A fifth wheel hitch assembly 14 (shown in phantom) is secured to the flat bed. The hitch assembly 14 is generally arranged to be located centrally over the rear axle of the towing vehicle 12 and generally equidistant from the sides of the towing vehicle 12. The trailer 10 includes a king pin 16 that may be secured by the hitch assembly 14 in a pair of jaws or other such securing or locking mechanism.

As shown in FIG. 1, the king pin 16 may be secured by the hitch assembly 14 such that the king pin 16 is aligned over the rear axle of the vehicle 12 and equidistant from the sides of the towing vehicle 12. In such an arrangement, the trailer 10 may be safely towed behind the towing vehicle 12 at operational speeds, such as speeds necessary to travel along highways and other thoroughfares. The placement of the king pin 16 over the rear axle provides a clearance C between the forward most portion 18 of the trailer 10 and the rearward most portion 20 of the towing vehicle cabin 22. Such clearance C is arranged such that the trailer 10 may be safely towed during normal towing operations. For example, the clearance C may be arranged to allow the towing vehicle 12 to make customary right and left hand turns without the forward most portion 18 of the trailer 10 hitting or otherwise contacting the rearward most portion 20 of the towing vehicle cabin 22.

However, as shown in FIG. 2, the clearance C in such an arrangement may be insufficient when the towing vehicle 12 and trailer 10 must be maneuvered in tight or confined spaces. For example, towing vehicles 12 and trailers 10 must often make tight turns when maneuvering in storage facilities, loading docks, warehouse facilities, campgrounds, and the like. Such areas offer little room between the towing vehicle 12 and trailer 10 and stationary objects such as parked vehicles, equipment, pillars, walls, and the like. Under such conditions, the towing vehicle 12 may need to turn at a sharp angle relative to the trailer 10, which may cause the forward most portion 18 of the trailer 10 to contact the rearward most portion 20 of the towing vehicle cabin 22. Such contact may cause damage to both the trailer 10 and the towing vehicle 12, and may even cause injury to the driver or bystanders.

To facilitate maneuvering in confined spaces, fifth wheel hitch assemblies may be arranged to allow the jaw or other such securing mechanism to slide longitudinally with respect to the flat bed of the towing vehicle. Such movement may provide more clearance between the forward most portion of a trailer and the rearward most portion of a cabin of a towing vehicle. Such enhanced clearance may allow the towing vehicle to make sharper turns without contacting and damaging the trailer.

To accomplish such sliding movement, the jaws or other securing mechanism may be selectively secured relative to the towing vehicle and may be selectively released relative to the towing vehicle to allow for sliding and longitudinal movement relative to the towing vehicle. Such an arrangement may allow for the jaws to be dynamically positioned with respect to the length of the flat bed. For example, the jaws may be effectively mounted onto mounting rails that are secured longitudinally to the flat bed of the towing vehicle. The jaws may be allowed to slide along the mounting rails and arranged to be locked to the mounting rails at different positions along the mounting rail, such as directly over the rear axle of the towing vehicle or rearward of the rear axle of the towing vehicle. Such dynamic positioning of the jaws allows for the jaws and king pin to be slid away from the cabin of the towing vehicle to create more clearance between the cabin and the trailer.

An exemplary method of moving the jaws, and thus the trailer, with respect to the flat bed is to unlock the jaws from the mounting rails and pull or drive the towing vehicle forward to slide the jaws and king pin longitudinally along the mounting rails to a position rearward of the rear axle of the towing vehicle. When the jaws and trailer are moved to a desired position, the jaws may again be locked to the mounting rails to allow the towing vehicle and the trailer to be successfully maneuvered in confined spaces. Once the towing vehicle and trailer are successfully maneuvered, the jaws may be unlocked from the mounting rails, the towing vehicle may be moved or driven backward until the jaws and king pin are again positioned over the rear axle of the towing vehicle. The jaws may then again be locked to the mounting rails. With the jaws and king pin positioned over the rear axle of the towing vehicle, the towing vehicle may again tow the attached trailer safely at operational speeds.

In an embodiment disclosed herein, a fifth wheel hitch assembly is attached to mounting rails, where the mounting rails are secured to a flat bed of a towing vehicle. The hitch assembly is attached to the mounting rails such that the hitch assembly may be either selectively locked and statically positioned along the mounting rails, or may be selectively unlocked to allowed the assembly to dynamically slide or otherwise move along the mounting rails. As used herein, a mode of a hitch assembly defines whether the assembly is unlocked and allowed to dynamically slide along the mounting rail or locked in a static position to the mounting rails. The mode of a hitch assembly may also define the location along the mounted rail at which the assembly is locked.

Fifth wheel hitch assemblies typically include a support frame for securing the hitch assembly to the bed of the towing vehicle. The support frame includes a pair of mounting rails, a pair of side brackets, and a head assembly. The mounting rails are bolted to the bed or the frame of the towing vehicle. The side brackets are secured to the mounting rails and the head assembly is secured to the side brackets. The head assembly is secured in a manner that allows the head assembly to pivot fore-and-aft with respect to the towing vehicle. The head assembly includes a jaw assembly for securing the king pin of the trailer to the towing vehicle. The jaws are arranged such that an operator may manually toggle the jaws between a position in which the king pin is secured in the jaws and a position in which the king pin is released from the jaws. When the king pin is secured in the jaws, the trailer is secured to the towing vehicle and may be safely towed by the towing vehicle. When the king pin is unsecured or otherwise released from the jaws, the king pin may be removed from the jaws, thus decoupling the trailer from the towing vehicle.

In an embodiment disclosed herein, apparatus and methods are provided for remotely altering, toggling, or otherwise changing the mode of a fifth wheel hitch assembly. In an embodiment disclosed herein, apparatus and methods are provided as visual and audible indicators that indicate the mode of the fifth wheel hitch assembly. Such indicators may include light emitting diode (LED) lights, flashing lights, sirens, speakers, buzzers, horns, and the like. The apparatus and methods may be incorporated into newly manufactured fifth wheel hitch assemblies or may be added to existing hitch assemblies to convert or retrofit such existing hitch assemblies into remotely controlled fifth wheel hitch assemblies. In addition, the apparatus and methods may include functionality to automatically lock the hitch assembly in a position as the hitch assembly is moved to that position along the mounting rail.

In an embodiment disclosed herein, a fifth wheel hitch assembly may be placed into three modes with respect to the mounting rails—an operational or travel mode, a maneuver mode, and a slide or moveable mode. The operational mode is a mode where the hitch assembly is statically secured or locked to the mounting rails such that any king pin secured to the hitch assembly is positioned above the rear axle of the towing vehicle. This positioning is generally optimal for normal towing operations; therefore, the hitch assembly is placed in the operational mode to allow the trailer is to be safely towed by the towing vehicle during normal operations.

The maneuver mode is a mode where the hitch assembly is statically secured or locked to the mounting rails such that any king pin secured to the hitch assembly is positioned rearward of the rear axle of the towing vehicle. The hitch assembly is placed in this mode to allow the towing vehicle and trailer to be safely maneuvered in tight and confined spaces. For example, when in the maneuver mode, the towing vehicle may be turned at a relatively sharp angle with respect to the trailer without a forward most portion of the trailer contacting a rearward most portion of the towing vehicle cabin.

The slide or moveable mode is a mode where the hitch assembly is slideable or otherwise moveable between the operational and maneuver modes. The hitch assembly is placed in slide mode to allow an operator to move the hitch assembly between the two static modes. For example, if the hitch assembly is initially in an operational mode, the hitch assembly can be placed in the slide mode and the hitch assembly can be moved rearward into the maneuver mode. One common method of moving or sliding the hitch assembly while in slide mode is to engage the brakes on the trailer and slowly move the towing vehicle forward or backward relative to the trailer. When moving the hitch assembly from an operational mode to a maneuver mode, the towing vehicle is generally moved forward with respect to the trailer. Conversely, when moving the hitch assembly from a maneuver mode to an operational mode, the towing vehicle is generally moved backward with respect to the trailer.

The mode of the hitch assembly can be toggled between either the operational and slide modes or the maneuver and slide modes by a remote control device. Such a remote control device may be mounted in the cabin of the towing vehicle, arranged to be handheld, or arranged in any manner that provides an operator with the ability to remotely change the mode of the hitch assembly. The remote control may be directly wired to the hitch assembly or may be a wireless device capable of communicating with the hitch assembly. In an embodiment, the remote control includes a number of indicators, such as LED lights for example, to indicate the current mode of the hitch assembly. In an embodiment, the apparatus may include audio indicators, such as speakers, sirens, buzzers, or horns to indicate the mode of the hitch assembly.

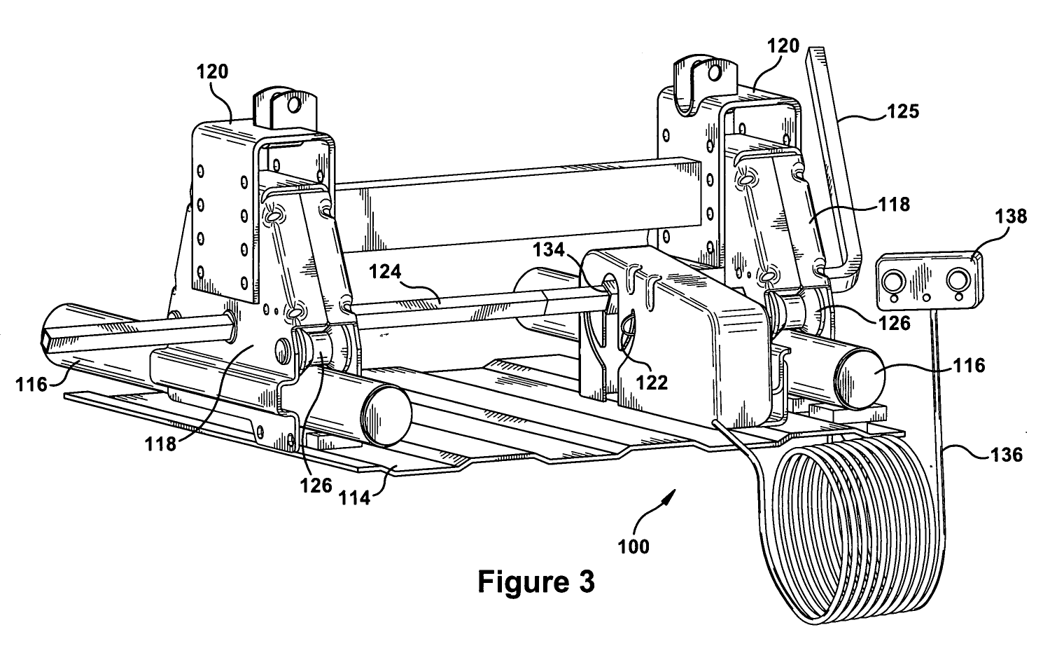

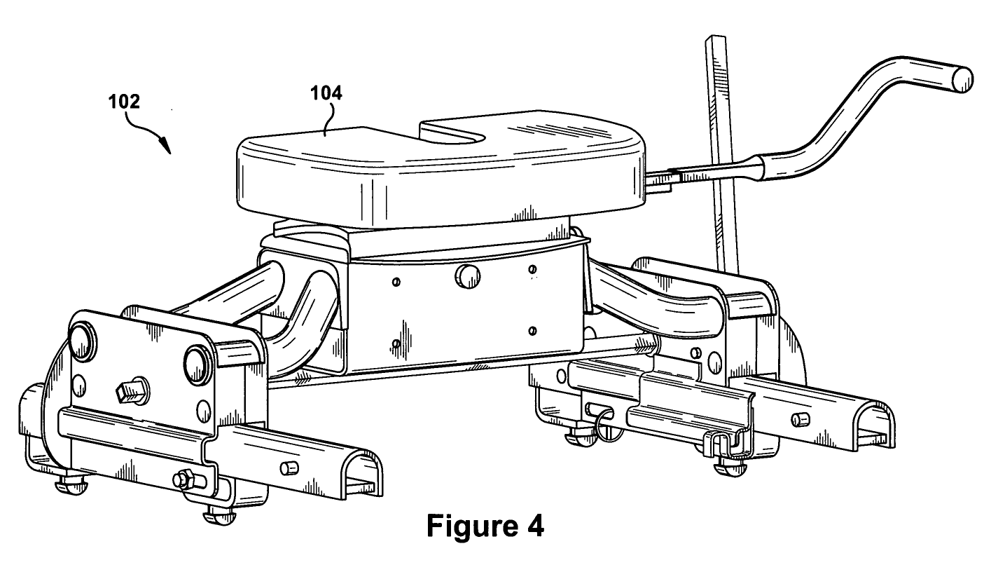

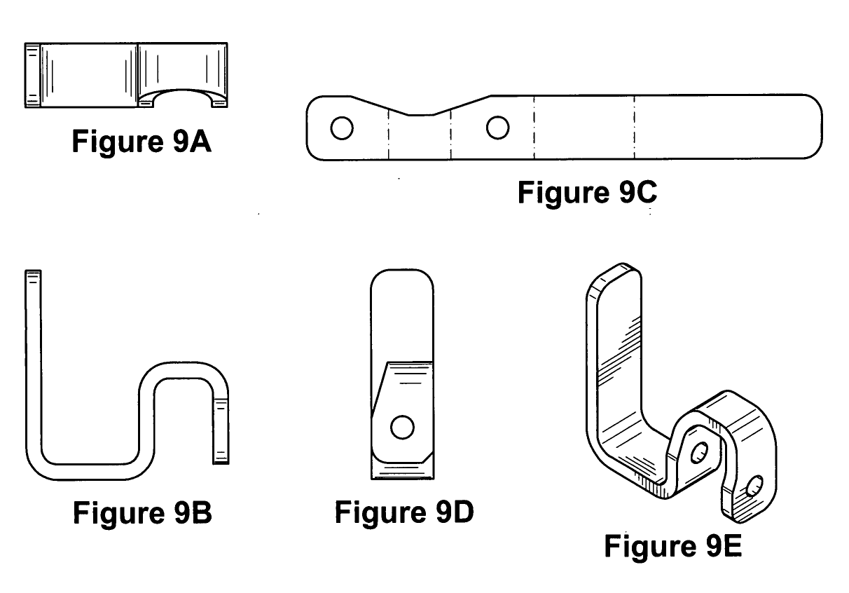

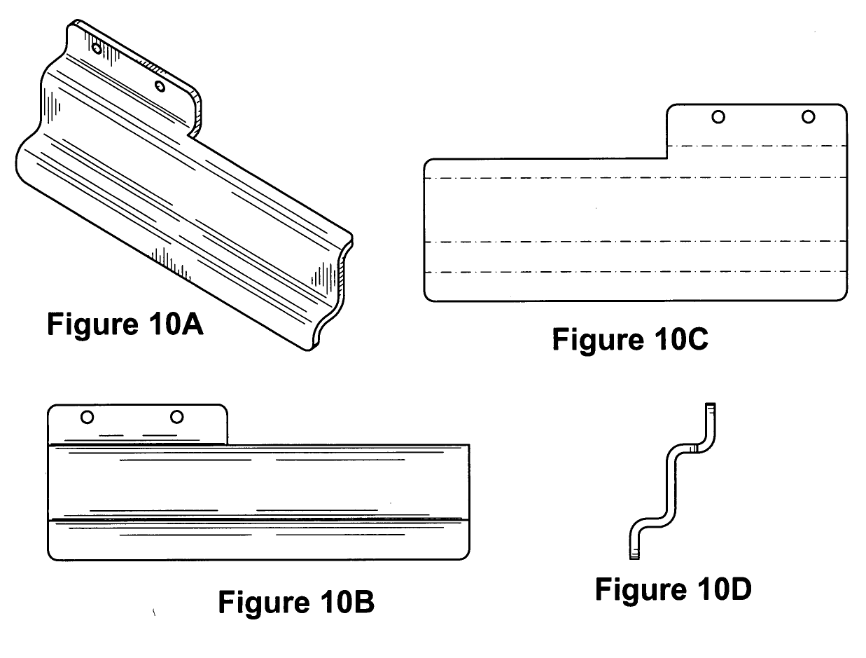

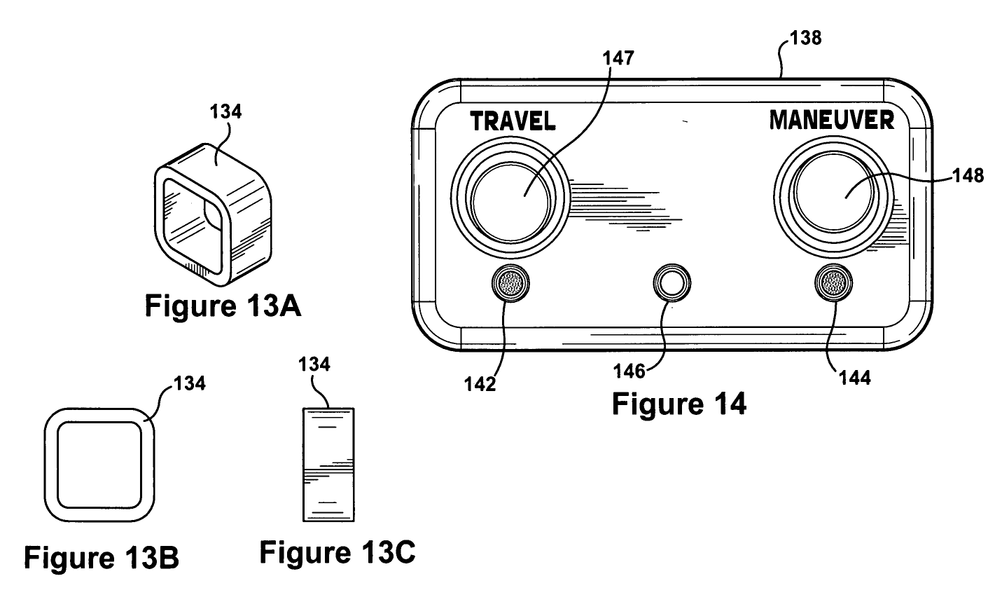

FIGS. 3 through 13 illustrate an exemplary embodiment of a remote controlled fifth wheel hitch assembly. The hitch assembly includes a linear slide actuation assembly 100 arranged to control the mode of a fifth wheel hitch assembly. An exemplary king pin locking mechanism 102 is illustrated in FIG. 4. The king pin locking mechanism 102 may be referred to as a head assembly or securing mechanism. The locking mechanism 102 may include a jaw 104 that may be arranged to selectively secure a king pin of a trailer. As will be subsequently described, the locking mechanism 102 may be mounted or otherwise slidably secured to the linear slide actuation assembly 100.

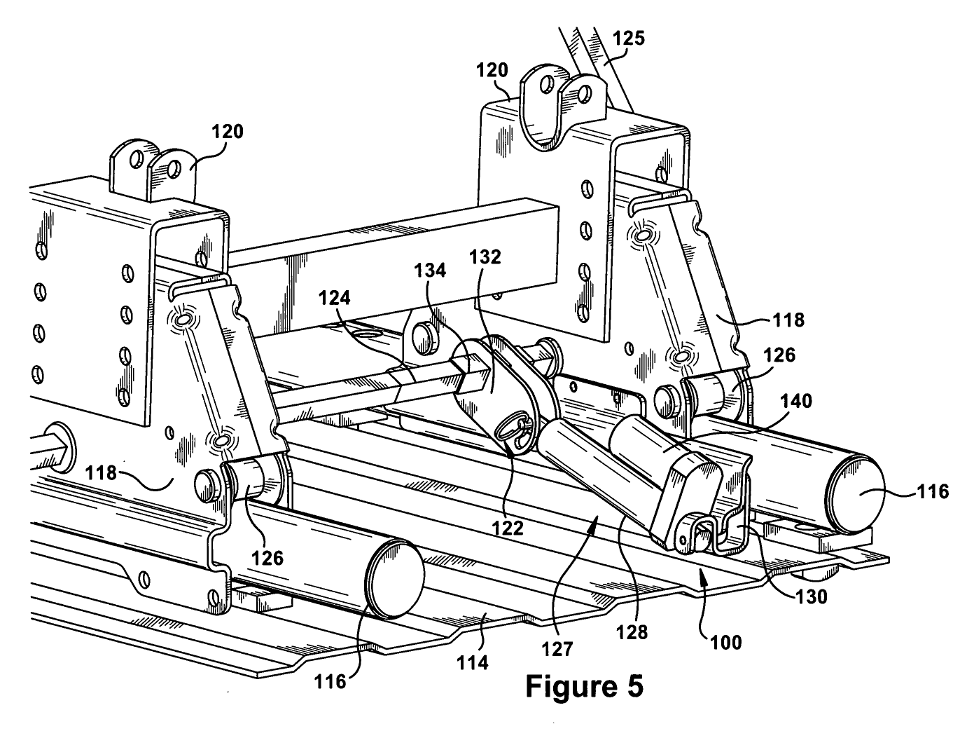

As best seen in FIG. 5, the slide actuator assembly 100 may be secured to a base plate 114, which is secured to the bed of a truck (not shown). A pair of mounting rails 116 is secured to the base plate 114. Alternatively, the mounting rails 116 may be secured directly to the flat bed of the towing vehicle or directly to the frame of the towing vehicle. A housing 118 is slideably coupled to each mounting rail 116, and a bracket 120 is secured to each housing 118. The king pin locking mechanism 102 or head assembly may be secured to the brackets 120 to form a fifth wheel hitch assembly. By securing the locking mechanism 102 to the brackets 120, the locking mechanism 102 will slide along the mounting rails 116 as the housings 118 slide along the mounting rails 116.

Coupled as used herein is defined as connected, either directly or indirectly. Two components that are coupled may have one or more intermediate components that are used to connect the components together. In addition to mechanical coupling, two components may be coupled electronically. For example two components may be coupled in such a way that electrical current passes from one component to the other.

As exemplified in FIG. 3, a mechanism may be provided for sliding the housings 118 and locking mechanism 102 along the mounting rails 116. For example, rollers 126 may engage the mounting rails 116 to facilitate movement of the housings 118 and locking mechanism 102 along the mounting rails 116. Mechanisms may also be provided for locking the housing 118 and locking mechanism 102 to a static position along the mounting rails 116. For example, spring-biased pins (not shown) may be coupled to the housings 118 to engage apertures (not shown) located in the mounting rail 116 to secure the housings 118 and locking mechanism 102 to the mounting rails 116. Such mechanisms may be arranged to define an operational mode or position and a maneuver mode or position.

A locking bar or arm 124 may be positioned to pass through the pair of housings 118. The locking bar 124 may be arranged so as to be rotatable between a locked position and an unlocked position. Optionally, the locking bar 124 may include a handle 125 to allow for manually rotating the locking bar 124 between locked and unlocked positions. When the locking bar 124 is in the unlocked position, the housings 118 and locking mechanism 102 are moveable between the operational and maneuver modes. When the locking arm 124 is in a locked position and the housings 118 are in either the operational mode or maneuver mode, the housings 118 and locking mechanisms 102 are generally secured to the mounting rails 116 and may not slide or otherwise move along the mounting rails 116.

The linear slide actuator assembly 100 is arranged to remotely rotate the locking bar 124 between the locked and unlocked positions. Referring to FIGS. 5 through 7, an actuator mechanism 127 is shown coupled on a first end to the base plate 114 and coupled on a second end to the locking arm 124. The actuator mechanism 127 includes a piston 128, a bracket assembly 130, and a cam arm assembly 132. The bracket assembly 130 secures the piston 128 to the base plate 114 or flat bed of the towing vehicle. The cam arm assembly 132 secures the piston 128 to the locking bar 124. A locking pin 122 is used to secure the piston 128 to the cam arm assembly 132. The pin 122 may be removed using a pull ring to detach the piston 128 from the cam arm assembly 132. The piston 128 may be detached for normal maintenance, service, or repair. Referring to FIG. 3, an electrical wire 136 places the slide actuator assembly 100 in electrical communication with a remote control device 138. Through the coupling of the remote control 138 and the slide actuator assembly 100, the remote control 138 may initiate the actuation mechanism 127 to move the locking arm 124 between locked and unlocked positions.

The cam arm assembly 132 includes a sleeve 134 that engages the locking arm 124 such that the locking arm 124 rotates as the sleeve 134 rotates. The sleeve 134 is illustrated as a square sleeve 134 that matches the square locking arm 124. It will be appreciated that the sleeve and locking arm may be any shape that allows for the rotation of the sleeve to rotate the locking arm. The piston 128 is arranged to selectively extend and retract to move or rotate the cam arm assembly 132. Such rotation of the cam arm assembly 132 rotates the sleeve 134, thus rotating the locking arm 124 between locked and unlocked positions.

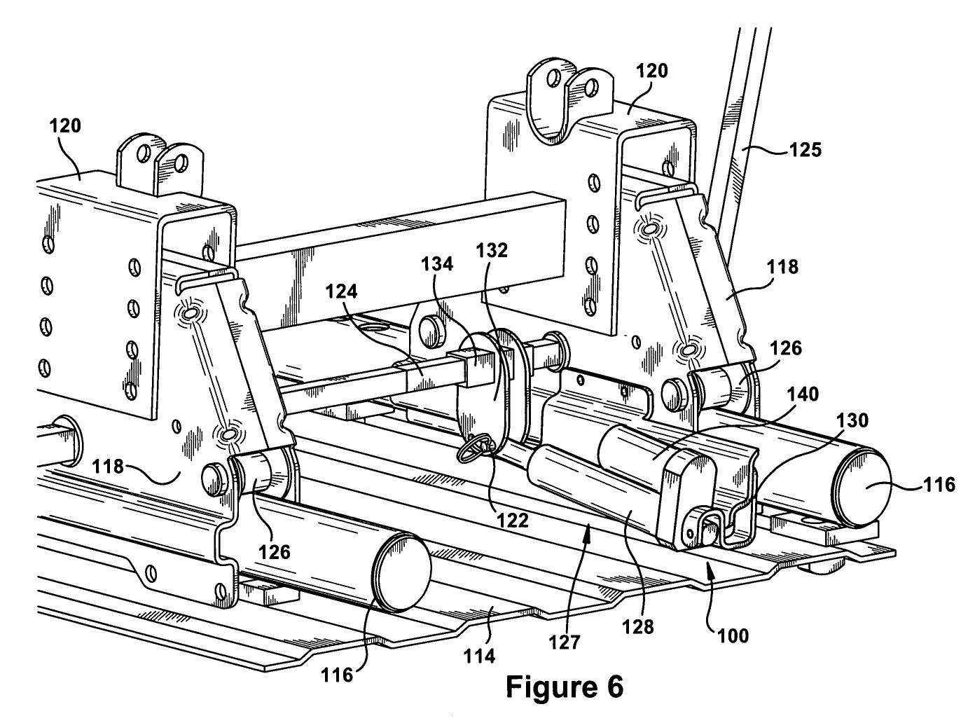

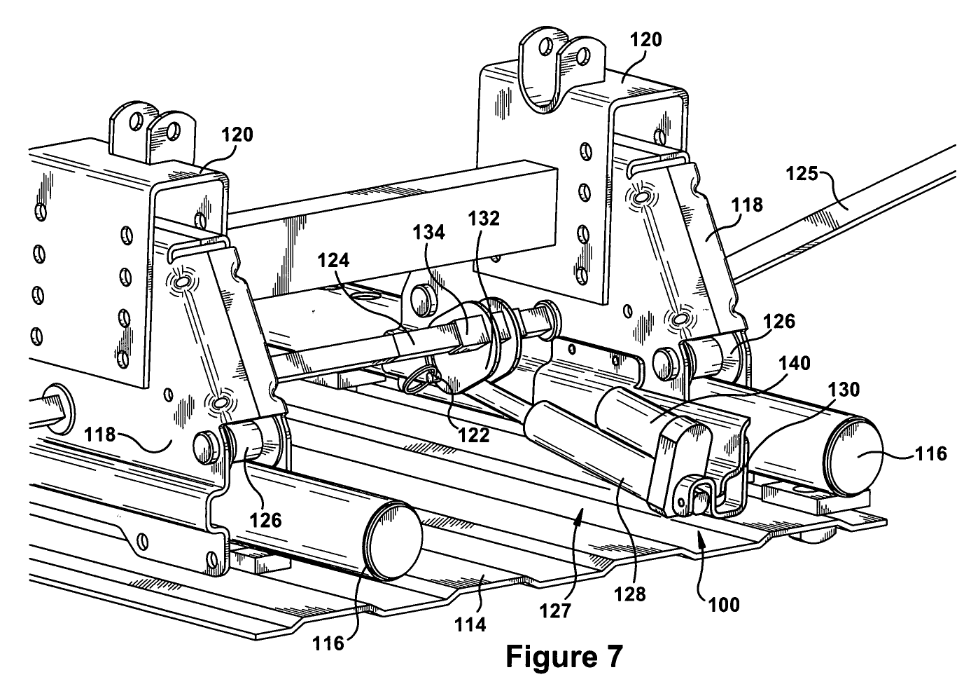

In one embodiment, illustrated in FIGS. 5 through 7, the piston extends and retracts to lock and unlock the locking arm 124. FIG. 5 illustrates the piston 128 in a fully retracted position and the locking arm 124 in the locked position. FIG. 6 illustrates the piston 128 in a partially extended position; wherein the locking arm 124 is rotated approximately 45 degrees. FIG. 7 illustrates the piston 124 in a fully extended position; wherein the locking arm 124 is rotated approximately an additional 45 degrees. The fully extended position of the piston 128 (as seen in FIG. 7) places the locking arm 124 in the unlocked position and the housings 118 and the locking mechanism 102 may be moved between operational and maneuver modes.

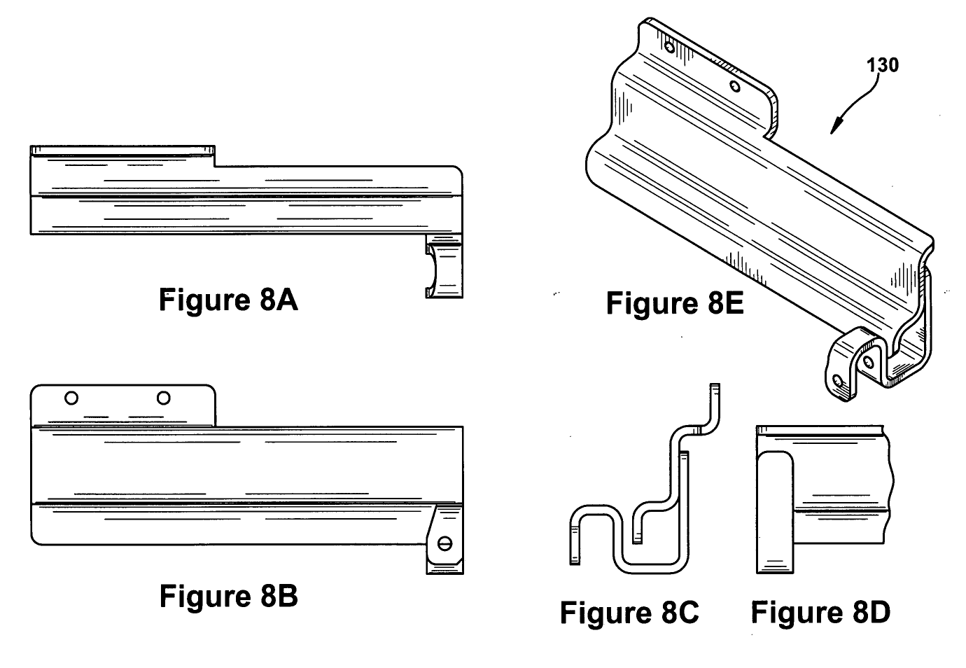

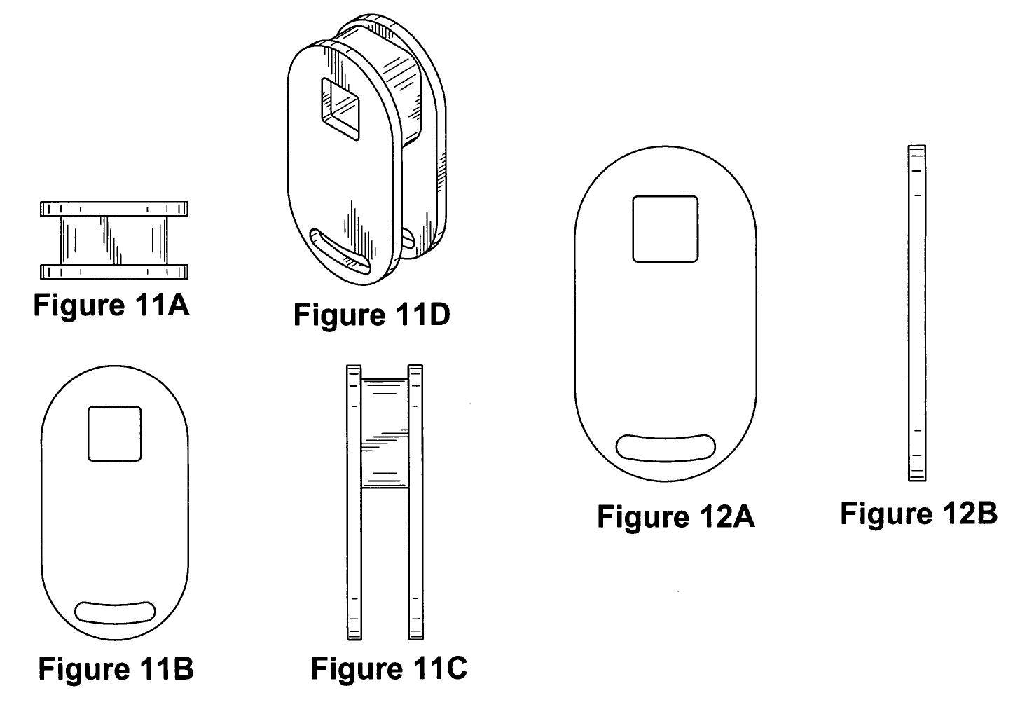

It will be readily appreciated that the process illustrated in FIGS. 5 through 7 may be reversed to move the locking bar 124 from the unlocked position to the locked position. This is accomplished by retracting the piston 128 from the fully extended position, as shown in FIG. 7, to the fully retracted position, shown in FIG. 5. Exemplary components of the bracket assembly 130 are shown in detail in FIGS. 8 though 10 and exemplary components of the cam arm assembly 132 are shown in detail in FIGS. 11 through 13.

The actuator mechanism 127 may include a motor 140 coupled to the piston 128. The motor 140 engages the piston 128 and powers the piston to move the piston 128 between the fully extended and the fully retracted positions. The motor 140 optionally receives power through the wire 136 from a power source, such as the towing vehicle battery (not shown) or a battery (not shown) specifically added to the towing vehicle or trailer to power the motor 140. It will be readily understood that the piston may be extended and retracted through a variety of methods such as, for example, through hydraulic pressure.

An embodiment of a remote controlled fifth wheel hitch assembly may include mechanisms to indicate or otherwise represent the mode of the assembly. The operational mode, maneuver mode, and slide mode each present some hazard for the operation of the towing vehicle. For example, when the hitch assembly is in the operational mode, maneuvering the towing vehicle and trailer in a confined or tight space may result in damage to the trailer or towing vehicle. When the hitch assembly is in a slide mode, the towing vehicle must be operated slowly and carefully to avoid damage and injury to the vehicle, trailer, operator, and bystanders. When the hitch assembly is in a maneuver mode, normal operation of the towing vehicle, such as driving the vehicle at highway speeds, may lead to damage to the vehicle and trailer, or to accidents. To reduce or eliminate such hazards, mechanisms or indicators may be included to indicate to the operator, workers, or bystanders the current mode of the hitch assembly.

In an embodiment of a fifth wheel hitch assembly, the remote control 138 includes a series of lights as indicators of the mode of the hitch assembly. An exemplary remote control device 138 is illustrated in FIG. 14. The remote control device 138 includes three indicator lights to display the mode of the hitch assembly to the vehicle operator or other interested party. An operational mode indicator light 142 illuminates when the hitch assembly is in the operational mode or position to indicate to the operator that the towing vehicle and trailer may safely be operated at normal operating speeds. A maneuver mode indicator light 144 illuminates when the hitch assembly is in the maneuver mode or position to indicate to the operator that the towing vehicle and trailer may be safely maneuvered in confined or tight spaces. A slide mode indicator light 146 illuminates when the hitch assembly is in the slide mode to indicate to the operator that the towing vehicle must be slowly moved to place the hitch assembly into either the operational mode or maneuver mode.

The indicator lights 142, 144, 146 may be arranged such that only one light may be illuminated at any point in time, thus reducing the possibility of operator confusion. The lights 142, 144, 146 may also be positioned and labeled on the remote control device 138 such that the operator may quickly and consistently determine which light is illuminated. Additionally, the indicator lights 142, 144, 146 may be arranged such that each light illuminates in a different color. For example, the operational mode light 142 may illuminate green, the maneuver mode light 144 may illuminate blue, and the slide mode light 146 may illuminate yellow. Such an arrangement further reduces or eliminates possible confusion by the operator.

The remote control device 138 may also include control buttons. In one embodiment, the remote control 138 includes an operational or travel mode button 147 and a maneuver mode button 148. When the hitch assembly is in the maneuver mode, the operator may engage the operational mode button 147 to place the locking arm 124 in the unlocked position and move the hitch assembly from the maneuver mode to the operational mode. Conversely, when the hitch assembly is in the operational mode, the operator may engage the maneuver mode button 148 to place the locking arm 124 in the unlocked position and move the hitch assembly from the operational mode to the maneuver mode. It will be appreciated that the remote control 138 may be equipped with a first button that moves the locking arm 124 from the locked position to the unlocked position and a second button that moves the locking arm 124 from the unlocked position to the locked position. In addition, it will be appreciated that the remote control 138 may be equipped with a single button that moves the locking arm 124 from the locked position to the unlocked position or between locked and unlocked positions.

In addition to lights on the remote control device 138, a number of other warning or indication systems may be included. For example, a flashing light may be mounted on the exterior of the towing vehicle or trailer to flash when the hitch assembly is in a slide mode, thus warning workers or bystanders that the towing vehicle may be moving the trailer between the travel and maneuver positions. A similar but distinctive flashing light may be included to indicate when the hitch assembly is in a maneuver mode. Since towing vehicles often are maneuvered in areas where workers or bystanders are present such as dock areas, warehouses, or campgrounds, such a visual warning may alert workers or bystanders that an operator may be maneuvering the towing vehicle and trailer. Audible alerts may also be included. Similar to the visual indicators, a siren, buzzer, horn, or other such audible warning device, may warn workers and bystanders that the towing vehicle and trailer are in a slide mode or a maneuver mode.

Hitch assemblies have been described and illustrated herein as including three modes or positions. However, upon reading and understanding the description and illustrations provided herein, it will be readily understood by those skilled in the art that a hitch assembly is not limited to three modes or positions.

In an embodiment of a hitch assembly, apparatus and methods may be arranged to include multiple maneuver modes or positions located rearward of the operational position. Such an arrangement allows an operator to more specifically set the clearance between the forward most portion of the trailer and rearward most portion of the towing vehicle cabin. The remote control may include additional lights and control buttons to accommodate the additional maneuver modes.

In another embodiment of a hitch assembly, apparatus and methods may be arranged to include a mode or position that locates the housings 118 and head assembly 102 forward of the operational position. Such an arrangement allows the operator to reduce the clearance between the forward most portion of the trailer and the rearward most portion of the cab. Reduced clearance may be desired when the towing vehicle and trailer are parked for long-term storage and limiting the space occupied by the vehicle and trailer is desirable. In addition, multiple modes or positions may be provided forward of the operational position to allow the operator to more specifically set the clearance between the forward most portion of the trailer and rearward most portion of the towing vehicle cabin. The remote control may include additional lights and control buttons to accommodate the additional modes.

Hitch assemblies have been described and illustrated in FIGS. 3 through 13 as including a linear slide actuator assembly 100 to remotely control the mode of the hitch assembly by moving the locking bar 124 between locked and unlocked positions. It will be readily understood by those skilled in the art that other actuation assemblies or mechanisms may be arranged to remotely lock and unlock the hitch assembly.

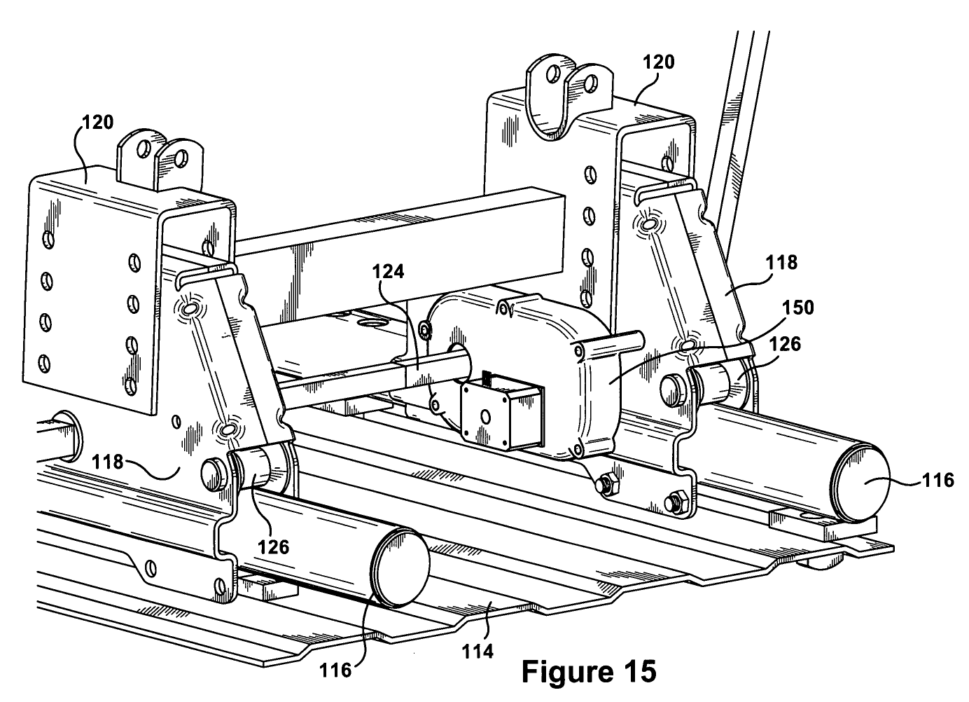

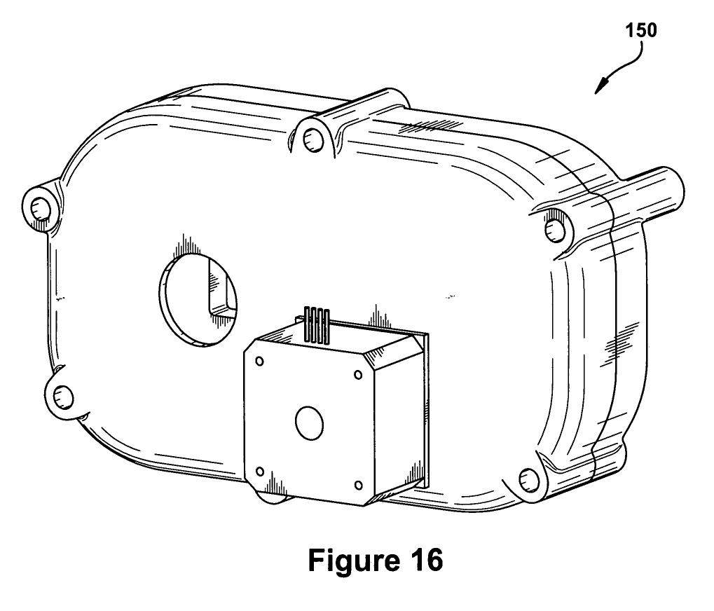

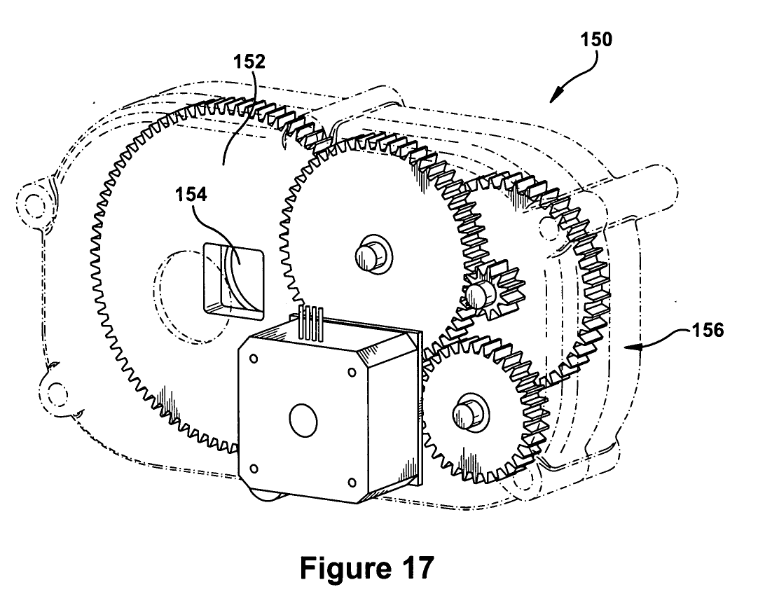

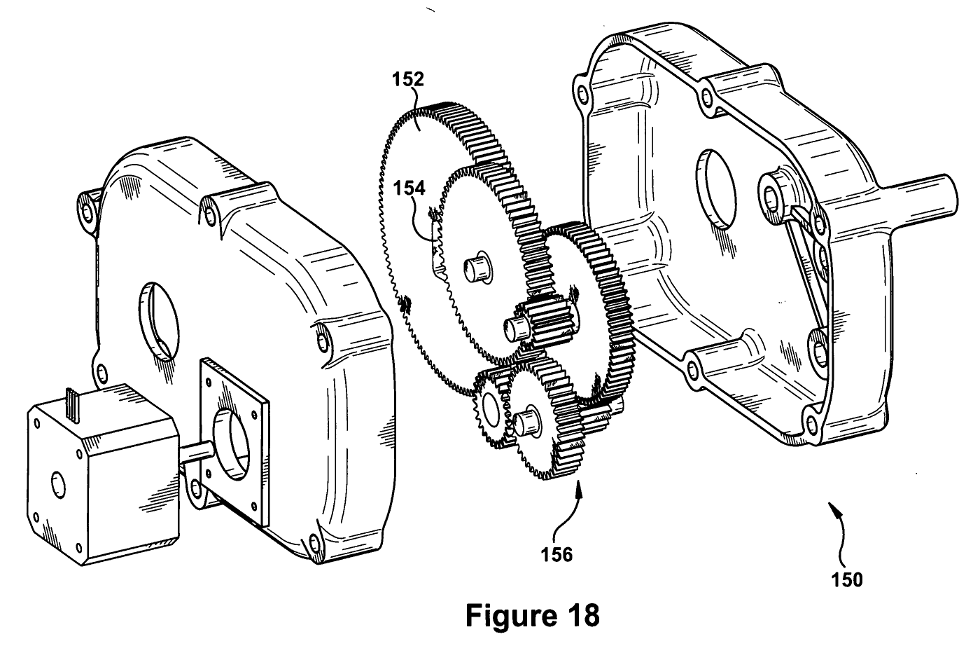

In an embodiment of a hitch assembly, as illustrated in FIGS. 15 through 18, a gearbox 150 may be engaged with the locking arm 124 to actuate the locking arm 124 between locked and unlocked positions. As illustrated in FIG. 15, the gearbox 150 may be mounted to the housing 118 such that the locking arm 124 passes through the gearbox 150. As illustrated in FIGS. 17 and 18, a main spur gear 152 includes a square aperture 154 sized to accept the square locking bar 124. A series of spur gears 156 are arranged to rotate the main gear 152, which in turn rotates the locking bar 124. As will be understood by those skilled in the art, the gearbox 150 may be arranged to accept command inputs from a remote control device such as those previously described. In addition, the gear box 150 may be arranged to accept power from a power source such as a vehicle battery to rotate the locking arm 124 between locked and unlocked positions. In another embodiment, worm gears are included in the gearbox in place of spur gears to rotate the locking arm 124 between locked and unlocked positions.

The linear slide actuator 100, gearbox 150, worm gears, or any other mechanism described herein and arranged to control the mode or position of the hitch assembly may be incorporated into a newly manufactured fifth wheel hitch assembly. In addition, any mechanism described herein and arranged to control the mode or position of the hitch assembly may be incorporated into an existing fifth wheel hitch assembly to retrofit such an existing assembly to one that is remotely controlled.

For example, a hitch assembly installed into the bed of a truck may be converted or retrofitted to a remote controlled hitch assembly by the incorporation of a linear slide actuator assembly 100. The bracket assembly 130 may secure one end of the piston 128 to the base plate 114. The sleeve 134 of the cam arm assembly 132 may be slid onto the existing locking arm 124, and the cam arm assembly 132 may be arranged to couple the opposite end of the piston 128 to the locking arm 124. The piston 128 may be coupled to a motor 140 and the motor 140 may be coupled to a remote control 138 and a power supply. Such an arrangement positions the linear slide actuator assembly 100 to remotely control the locking arm 124. Similarly, the gearbox 150 can be coupled to the housing 118 of the hitch assembly and the locking arm 124 can be passed through the main gear 152. Once the remote control and power supply are coupled to the gearbox 150, the locking arm 124 may be remotely moved between the locked and unlocked positions.

In an embodiment of a fifth wheel hitch assembly, apparatus and methods may include functionality to automatically lock the housings 118 and locking mechanism 102 to a position along the mounting rails 116. Such functionality may automatically lock the housings 118 and locking mechanism 102 as the hitch assembly is slid along the mounting rails 116 while in the maneuver mode. For example, biased securing pins coupled to the housings 118 may be arranged to engage apertures along the mounting rails 116 when the pins are moved to align with such apertures. For example, a first aperture may be positioned to coincide with the operational mode or position and a second aperture may be arranged to coincide with the maneuver mode or position.

In an embodiment, the springs are arranged to encourage or otherwise bias the securing pins against the mounting rails 116 such that when the hitch assembly is moved into a position that aligns the pins with the apertures in the mounting rails 116 that correspond to the operational position, the springs automatically move the pins into engagement with those apertures. Similarly, when the hitch assembly is positioned to align the pins with the apertures in the mounting rails 116 that correspond to the maneuver position, the springs automatically move the pins into engagement with those apertures. In such an arrangement, the pins are disengaged or otherwise moved out of the apertures by the rotation of the locking bar 124 from the locked to the unlocked position, thus freeing the housings 118 and locking mechanism 102 to move along the mounting rails 116 when in the slide mode.

Although the preferred embodiments of the present invention has been illustrated in the accompanying drawing and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, we claim:

1. A remotely controlled fifth wheel hitch assembly comprising:
a first mounting rail coupled to a towing vehicle;
a head assembly slidably coupled to the first mounting rail, the head assembly capable of securing a trailer to the towing vehicle;
a locking arm including a locked position and an unlocked position, wherein the locked position statically secures the head assembly to the first mounting rail;
an actuation mechanism coupled to the locking arm to move the locking arm between the locked and unlocked positions; and
a remote control device coupled to the actuation mechanism to initiate the actuation mechanism to move the locking arm between the locked and unlocked positions.

2. The assembly of claim 1, wherein the actuation mechanism comprises a piston coupled on a first end to the towing vehicle and coupled on a second end to the locking arm.

3. The assembly of claim 2, wherein the piston includes an extended position and a retracted position;
further wherein, the piston moves the locking arm between locked and unlocked positioned by moving between the retracted and extended positions.

4. The assembly of claim 1, wherein the actuation mechanism comprises a gear coupled to the locking arm.

5. The assembly of claim 4, wherein the gear is a spur gear.

6. The assembly of claim 4, wherein the gear is a worm gear.

7. The assembly of claim 1 further comprising:
a first housing coupled to the head assembly and coupled to the first mounting rail; and
a first roller disposed between the first housing and the first mounting rail.

8. The assembly of claim 7 further comprising:
a second mounting rail;
a second housing coupled to the head assembly and coupled to the second mounting rail; and
a second roller disposed between the second housing and the second mounting rail.

9. The assembly of claim 1, wherein the remote control includes at least one indicator to indicate if the head assembly is statically coupled to the first mounting rail.

10. The assembly of claim 9, wherein the at least one indicator is a light.

11. The assembly of claim 1, wherein the remote control includes at least one control button to initiate the actuation mechanism.

13. The assembly of claim 1, further comprising at least one indicator to indicate if the head assembly is statically coupled to the first mounting rail.

14. The assembly of claim 13, wherein the indicator is an audio device.

15. The assembly of claim 13, wherein the indicator is an illumination device.

16. The assembly of claim 1, wherein the head assembly may be statically secured to the first mounting rail at a plurality of locations.

17. The assembly of clam 16, wherein a one of the plurality of positions is above a rear axle of the towing vehicle.

18. The assembly of clam 16, wherein a one of the plurality of positions is rearward of a rear axle of the towing vehicle.

19. A method for remotely controlling a fifth wheel hitch assembly comprising:
mounting a rail to a towing vehicle;
slidably coupling a head assembly to the rail;
selectively statically securing the head assembly to the rail by moving a locking arm; and
remotely initiating an actuation mechanism to move the locking arm to statically secure the head assembly to the rail.

20. The method of claim 19, further comprising:
observing a remote control to determine if the head assembly is statically secured to the rail.
